(19) United States
(12) Patent Application Publication
(10) Pub. No.: US 2017/0150106 A1
(43) Pub. Date: May 25, 2017

(54) LIQUID COOLING APPARATUS, PROJECTOR AND APPARATUS HAVING A HEAT SOURCE

(71) Applicant: COOLER MASTER CO., LTD., NEW TAIPEI CITY (TW)

(72) Inventors: Shih-Wei HUANG, NEW TAIPEI CITY (TW); Shui-Fa TSAI, NEW TAIPEI CITY (TW)

(21) Appl. No.: 15/014,005

(22) Filed: Feb. 2, 2016

(30) Foreign Application Priority Data
Nov. 24, 2015 (TW) 104218884

(51) Int. Cl. H04N 9/31; F28F 3/02; G02B 26/08

(52) U.S. Cl. CPC H04N 9/3144; H04N 9/3102; G02B 26/0833; F28F 3/02

(57) ABSTRACT

In a liquid cooling apparatus, a projector and an apparatus having a heat source, the liquid cooling apparatus includes a chassis and a cover. The chassis has upper and lower surfaces, a boss protruded from the lower surface, and a recessed groove formed on the upper surface and inside the boss. The boss has an area smaller than 50% of the area of the lower surface. The cover covers the chassis, and a cavity is formed inside the cover and the chassis. The cover has liquid inlet and outlet channels communicated with the cavity. The recessed groove improves the thermal conduction and heat exchange performance of the liquid cooling apparatus. The boss has an area smaller than 50% of the area of the lower surface and is thermally attached to the heat source more securely to provide excellent heat dissipating efficiency to both projector and liquid cooling apparatus.

### FIELD OF THE INVENTION

The technical field relates to a heat dissipating structure, more particularly to a liquid cooling apparatus, a projector, and an apparatus having a heat source.

### BACKGROUND OF THE INVENTION

Projector is a display device using a special structured projection tube or liquid crystal display (LCD) panel to collocate with an optical system to amplify an image and project the amplified image onto a screen. Since electronic components of the optical system usually generate heat of high temperature, it is necessary to have a water cooling radiator to dissipate the heat generated by the electronic components.

In addition, some of the electronic components in the projector are installed at a recession. For example, a Digital Micro-mirror Device (DMD) chip is exposed from an opening of a circuit board, which causes a requirement of protruding a small boss from the bottom of a water cooling radiator so that the water cooling radiator can be passed and installed at the opening of the circuit board and thermally attached to the DMD chip, and finally the boss conducts the heat generated by the electronic component to the water cooling radiator for the purpose of dissipating heat.

However, the aforementioned boss is a solid structure with poor thermal conduction and heat exchange, and the area of the bottom of the water cooling radiator must be relatively proportional to the area of the boss before the bottom of the water cooling radiator can be attached stably to the circuit board in order to stably and thermally attach the boos and the DMD chip with each other.

In view of the aforementioned problems of the prior art, the discloser of this disclosure based on years of experience in the related industry to conduct extensive researches and experiments, and finally provided a feasible solution to overcome the problems of the prior art.

### SUMMARY OF THE INVENTION

It is a primary objective of this disclosure to provide a liquid cooling apparatus, a projector and an apparatus having a heat source, wherein a recessed groove is concavely formed on an upper surface and inside a boss to improve the thermal conduction and heat exchange performance of the liquid cooling apparatus, and the boss has an area smaller than 50% of the area of the lower surface, so that the boss can be thermally attached to the heat source more securely, and the projector and the liquid cooling apparatus have an excellent heat dissipating efficiency.

To achieve the aforementioned and other objectives, this disclosure provides a liquid cooling apparatus, comprising: a chassis, having an upper surface, a lower surface, a boss outwardly protruded from the lower surface, and a recessed groove concavely formed on the upper surface and inside the boss, and the boss having an area smaller than 50% of the area of the lower surface; and a cover, covering the chassis, and the cover and the chassis jointly having a cavity formed therein, and the cover having a liquid inlet channel and a liquid outlet channel, and the liquid inlet channel and the liquid outlet channel communicating with the cavity separately.

To achieve the aforementioned and other objectives, this disclosure provides a projector, comprising: a projection module, having at least one first planar layer and a second planar layer stacked on the top of the first planar layer, and the first planar layer having a through slot exposed from a portion of the second planar layer, and a height difference existing between the first planar layer and the second planar layer, a heat source, installed on the second planar layer, and exposed from the first planar layer through the through slot; a liquid cooling apparatus, installed on the first planar layer, and comprising: a chassis, having an upper surface, a lower surface, a boss outwardly protruded from the lower surface, and a recessed groove concavely formed on the upper surface and inside the boss, and the boss having an area smaller than 50% of the area of the lower surface; and a cover, covering the chassis, and the cover and the chassis jointly having a cavity formed therein, and the cover having a liquid inlet channel and a liquid outlet channel, and the liquid inlet channel and the liquid outlet channel communicating with the cavity separately, and the boss being passed and installed to the through slot and thermally attached to the heat source.

To achieve the aforementioned and other objectives, this disclosure provides an apparatus having a heat source, comprising: a first planar layer, having a through area; a second planar layer, stacked on the first planar layer, and a height difference existing between the first planar layer and the second planar layer; a heat source, installed on the second planar layer, and exposed from the first planar layer through the through area; and a liquid cooling apparatus, installed on the first planar layer, and comprising: a chassis, having an upper surface, a lower surface, a boss outwardly protruded from the lower surface, and a recessed groove concavely formed on the upper surface and inside the boss, and the boss having an area smaller than 50% of the area of the lower surface; and a cover, covering the chassis, and the cover and the chassis jointly having a cavity formed therein, and the cover having a liquid inlet channel and a liquid outlet channel, and the liquid inlet channel and the liquid outlet channel communicating with the cavity separately, and the boss being passed and installed to the through slot and thermally attached to the heat source.

This disclosure has the following effect:

1. The boss has an area smaller than 50% of the area of the lower surface, or a length smaller than 70% of the length of the upper surface and a width smaller than 70% of the width of the upper surface to facilitate fixing and positioning the liquid cooling apparatus, so that the boss is thermally attached to the heat source more securely, and the projector and the liquid cooling apparatus have an excellent heat dissipating efficiency.

2. The boss has a length from 1.0 cm to 4.0 cm, a width from 1.0 cm to 4.0 cm, and a thickness from 0.5 cm to 1.5 cm, so that the boss can be thermally attached to the heat source more conveniently.

3. The bottom wall of the recessed groove is coupled to a plurality of fins, each having a top lower than the upper surface or aligned evenly with the upper surface, so that when the liquid inlet channel guides a working fluid to the plurality of fins, the working fluid will hit the flat upper surface first and then enter into the recessed groove to prevent the working fluid from hitting the fins quickly or directly or producing turbulence and choked flow, so that the working fluid can flow smoothly into the recessed groove and the bottom wall to achieve the effect of improving the heat dissipating efficiency of the liquid cooling apparatus.

### BRIEF DESCRIPTION OF THE DRAWINGS

FIG. 1 is a perspective view showing of a liquid cooling apparatus of this disclosure;

FIG. 2 is another perspective view of a liquid cooling apparatus of this disclosure;

FIG. 3 is a cross-sectional view of a liquid cooling apparatus of this disclosure;

FIG. 4 is a perspective view of a projector of this disclosure;

FIG. 5 is a cross-sectional view of a projector of this disclosure;

FIG. 6 is a cross-sectional view of a liquid cooling apparatus in accordance with another preferred embodiment of this disclosure;

FIG. 7 is a perspective view of a liquid cooling apparatus in accordance with a further preferred embodiment;

FIG. 8 is a cross-sectional view of a liquid cooling apparatus in accordance with a further preferred embodiment;

FIG. 9 is a top view of a first planar layer of this disclosure;

FIG. 10 is a top view of a first planar layer in accordance with another preferred embodiment of this disclosure;

FIG. 11 is a top view of a first planar layer in accordance with a further preferred embodiment of this disclosure; and

FIG. 12 is a top view of a first planar layer in accordance with a further preferred embodiment of this disclosure.

### DESCRIPTION OF THE PREFERRED EMBODIMENTS

The technical contents of this disclosure will become apparent with the detailed description of preferred embodiments accompanied with the illustration of related drawings as follows. It is intended that the embodiments and figures disclosed herein are to be considered illustrative rather than restrictive.

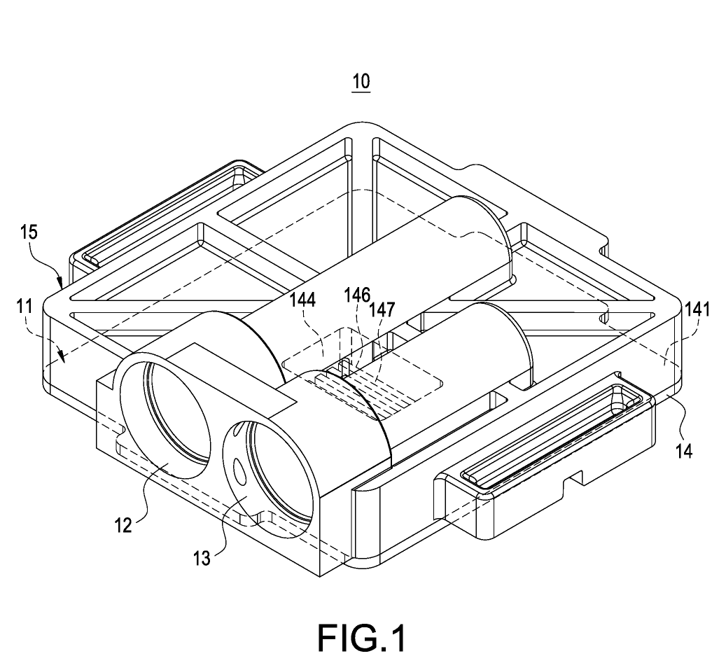

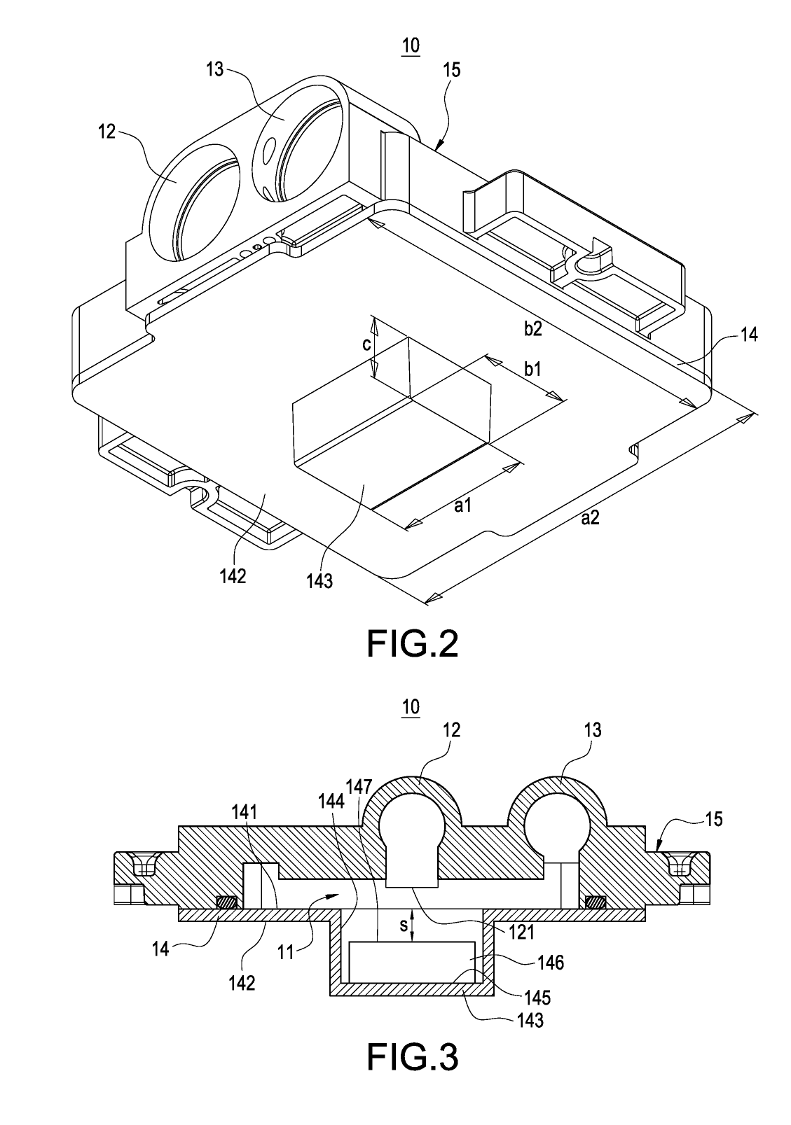

With reference to FIGS. 1 to 5, this disclosure provides a liquid cooling apparatus, a projector and an apparatus having a heat source, and the liquid cooling apparatus 10 comprises a chassis 14 and a cover 15, and the projector 100 comprises a projector module 2, a heat source 3, and a liquid cooling apparatus 10.

In FIGS. 1 to 3, the chassis 14 has an upper surface 141, a lower surface 142, a boss 143 outwardly protruded from the lower surface 142, and recessed groove 144 concavely formed on the upper surface 141 and inside the boss 143, and the boss 143 has an area smaller than 50% of the area of the lower surface 142, wherein the area of the boss 143 is equal to the length al of the boss 143 multiplied by the width b1 of the boss 143, and the area of the lower surface 142 is equal to the length a2 of the upper surface 141 multiplied by the width b2 of the upper surface 141. Wherein, the chassis 14 is made of a material with high thermal conductivity such as copper, aluminum, etc.

Specifically, in this embodiment, the boss 143 has a length a1 smaller than 70% of the length a2 of the upper surface 141 and a width b 1 smaller than 70% of the width b2 of the upper surface 141, wherein the boss 143 has a length al from 1.0 cm to 4.0 cm, a width b1 from 1.0 cm to 4.0 cm, and a thickness c from 0.5 cm to 1.5 cm. However, the above embodiment is not to limit the size of the boss only.

In addition, the recessed groove 144 has a bottom wall 145 on which a plurality of fins 146 is configured, each having a top 147 lower than the upper surface 141, and a spacing s is defined between the top of the fins and the upper surface 141, and each of the fins 146 is a sheet body.

The cover 15 covers the chassis 14, and the cover 15 and the chassis 14 jointly form a cavity 11 therein, and the cover 15 has a liquid inlet channel 12 and a liquid outlet channel 13, and the liquid inlet channel 12 and the liquid outlet channel 13 communicate with the cavity 11 separately, and the liquid inlet channel 12 has a liquid inlet 121 configured to be corresponsive to the top of each respective fin 146.

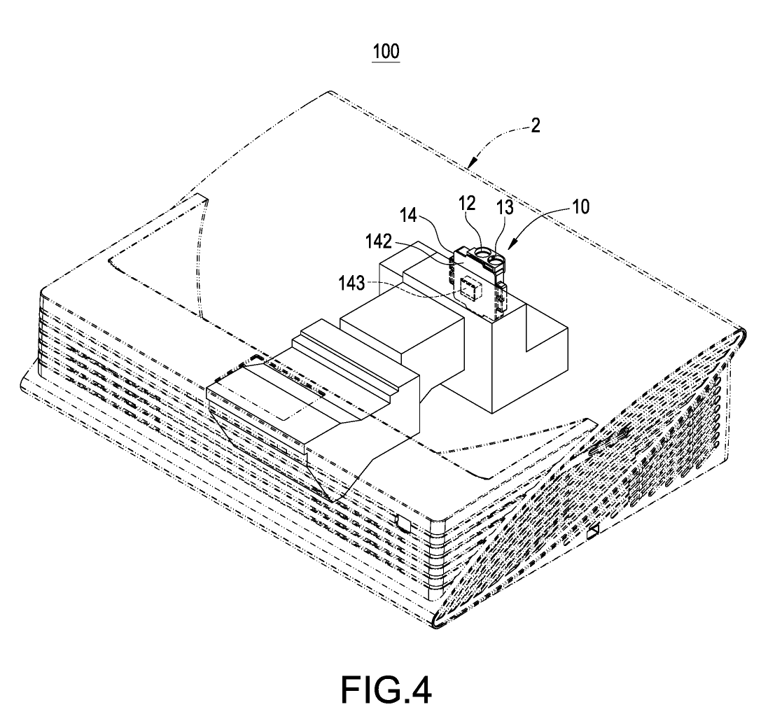

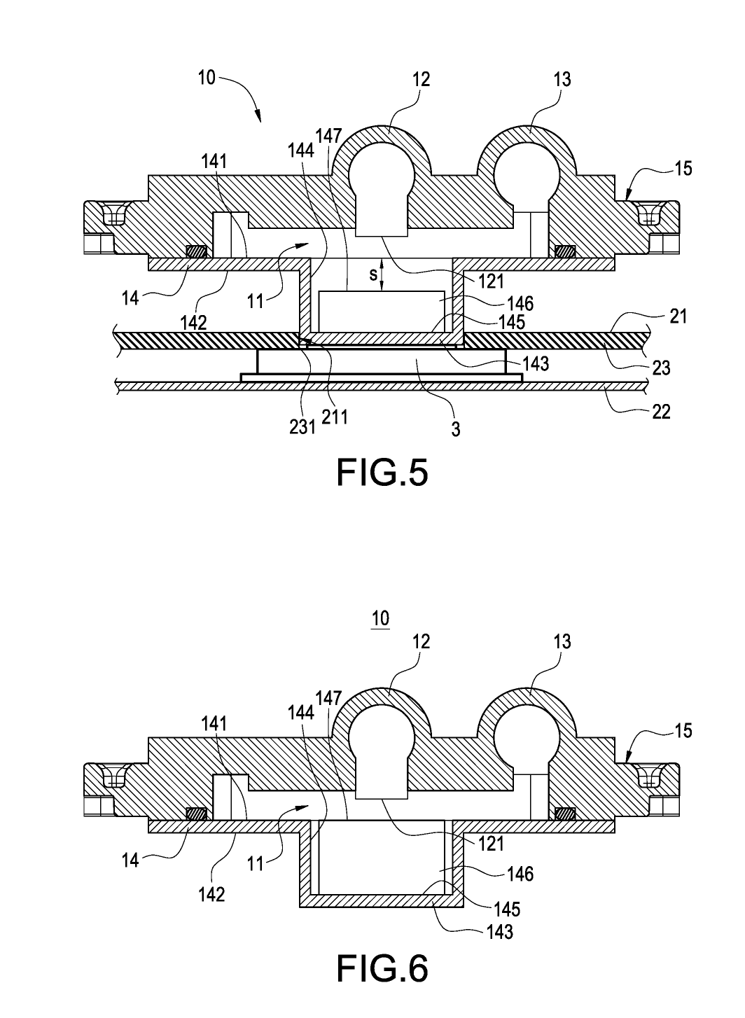

In FIGS. 4 and 5, the projector module 2 has at least one first planar layer 21 and a second planar layer 22, and the first planar layer 21 has a through slot 231 exposed from a portion of the second planar layer 22, and a height difference exists between the first planar layer 21 and the second planar layer 22. Wherein, the through slot 231 has a length from 1.5 cm to 4.5 cm and a width from 1.5 cm to 4.5 cm.

In addition, at least one of the first planar layer 21 and the second planar layer 22 is a circuit board 23. In this preferred embodiment, the first planar layer 21 is a circuit board 23, but this disclosure is not limited to such arrangement only, and the second planar layer 22 may also be a circuit board.

In this embodiment, the heat source 3 is, for example, a Digital Micro-mirror Device (DMD) chip, and the heat source 3 is installed on the second planar layer 22 and exposed from the first planar layer 21 through the through slot 231. Wherein, the liquid cooling apparatus 10 is installed on the first planar layer 21, and the boss 143 is passed and installed to the through slot 231 and thermally attached to the heat source 3.

With reference to FIGS. 1 to 3 for an assembly of a liquid cooling apparatus 10 of this disclosure, the liquid cooling apparatus comprising a chassis 14 having an upper surface 141, a lower surface 142, a boss 143 outwardly protruded from the lower surface 142, and a recessed groove 144 concavely formed on the upper surface 141 and inside the boss 143, and the boss 143 has an area smaller than 50% of the area of the lower surface 142, and the cover 15 covers the chassis 14, and the cover 15 and the chassis 14 jointly having a cavity 11 formed therein, and the cover 14 has a liquid inlet channel 12 and a liquid outlet channel 13, and the liquid inlet channel 12 and the liquid outlet channel 13 communicate to the cavity 11 separately.

With reference to FIGS. 4 and 5 for an assembly of a projector of this disclosure, the projector 100 comprises a projection module 2 having a first planar layer 21 and a second planar layer 22 stacked on the first planar layer 22. The first planar layer 21 has a through slot 231 exposed from a portion of the second planar layer 22. A height difference existing between the first planar layer 21 and the second planar layer 22. In addition, a heat source 3 is installed on the second planar layer 22, and exposed from the first planar layer 21 through the through slot 231. Furthermore, the aforementioned liquid cooling apparatus 10 is installed on the first planar layer 21, and the boss 143 is passed and installed into the through slot 231 and thermally attached to the heat source 3.

With reference to FIGS. 1 to 5 for a using status of the liquid cooling apparatus 10 of this disclosure, the liquid cooling apparatus 10 guides a working fluid (such as refrigerant or water) into the cavity 11 and the recessed groove 144 through the liquid inlet channel 12, such that the heat generated by the heat source 3 is conducted through the boss 143 and the fins 146 to the working fluid, and finally the working fluid is guided out from the liquid cooling apparatus 10 through the liquid outlet channel 13 to carry the heat out of the liquid cooling apparatus 10. It is noteworthy that the conventional solid boss is substituted by the boss 143 with a recessed groove 141 formed therein, and the recessed groove 144 is coupled to a fin 146 to conduct the heat generated by the heat source 3 quickly to the working fluid by the contact with the fin 146, so as to improve the thermal conduction and the heat exchange performance of the liquid cooling apparatus 10.

In addition, the boss 143, for example, has an area smaller than 50% of the area of the lower surface 142, or the boss 143 has a length al smaller than 70% of the length of the upper surface 141 and a width b1 smaller than 70% of the width of the upper surface 141, so that the lower surface 142 with a larger area can be installed to the first planar layer 21 to facilitate fixing and positioning the liquid cooling apparatus 10. For example, the liquid cooling apparatus 10 is locked or secured onto the first planar layer 21, so that the boss 143 can be thermally attached to the heat source 3 more securely to achieve excellent heat dissipating efficiency of the projector 100 and the liquid cooling apparatus 10.

In addition, if the heat source 3 is, for example, a Digital Micro-mirror Device (DMD) chip, the first planar layer 21 includes a through slot 231 formed thereon and having a length from 1.5 cm to 4.5 cm and a width from 1.5 cm to 4.5 cm, and the liquid cooling apparatus 10 requires a locking space, so that the boss 143 has a length al from 1.0 cm to 4.0 cm, a width b1 from 1.0 cm to 4.0 cm, and a thickness c from 0.5 cm to 1.5 cm to fit the size of the through slot 231 and thermally attach to the heat source 3 more conveniently.

In addition, if the liquid inlet 121 of the liquid inlet channel 12 guides the working fluid to the plurality of fins 146 quickly and the top 147 of the fin 146 is higher than the upper surface 141, then the working fluid will hit the fin 146 first to produce turbulence and choked flow and cause the working fluid unable to enter into the recessed groove 144 or the bottom wall 145. However, the top 147 of each of the fins 146 of this disclosure is lower than the upper surface 141 and a spacing s is formed between the top 147 of the fin 146 and the upper surface 141, so that the working fluid will hit the flat upper surface 141 before entering into the spacing s and will decelerate, and finally will flow between the plurality of fins 146, so as to prevent the working fluid from hitting the fin 146 quickly or producing turbulence and choked flow, and to allow the working fluid to flow to the interior of the recessed groove 144 and the bottom wall 145, and achieve the effect of improving the heat dissipating efficiency of the liquid cooling apparatus 10.

With reference to FIGS. 4 and 5 for a liquid cooling apparatus 10 of this disclosure, the liquid cooling apparatus 10 is applicable to the aforementioned projector 100 as well as any other apparatus having a heat source such as a printer, a cloud server, an electric power system, etc.

Specifically, the apparatus having a heat source and using the liquid cooling apparatus 10 of this disclosure is similar to the projector 100 and comprises a first planar layer 21, a second planar layer 22, a heat source 3 and a liquid cooling apparatus 10, wherein the first planar layer 21 has a through area 211; the second planar layer 22 and the first planar layer 21 are stacked with one another, and a height difference exists between the first planar layer 21 and the second planar layer 22; a heat source 3 disposed on the second planar layer 22 and exposed from the first planar layer 21 through the through area 211; a liquid cooling apparatus 10 installed on the first planar layer 21, and the boss 143 being passed and installed in the through area 211 and thermally attached to the heat source 3. Therefore, the liquid cooling apparatus 10 of this disclosure may be applied to the aforementioned apparatus having a heat source, wherein the heat source 3 is an integrated circuit.

With reference to FIG. 6 for a cooling apparatus 10 in accordance with another preferred embodiment of this disclosure liquid, this preferred embodiment is substantially the same as that of the preferred embodiment as shown in FIGS. 1 to 5, except that each of the fins 146 of this preferred embodiment has a top 147 aligned evenly with the upper surface 141. Therefore, the top 147 of each of the fins 146 of this disclosure may be installed and aligned evenly with the upper surface 141 or lower than the upper surface 141, so that if the liquid inlet 121 of the liquid inlet channel 12 guides the working fluid to the plurality of fins 146 quickly, then the working fluid will hit the flat upper surface 141 first before entering into the recessed groove 144, so as to prevent the working fluid from hitting the fin 146 quickly and directly to produce turbulence and choked flow and allow the working fluid to flow to the interior of the recessed groove 144 and the bottom wall 145.

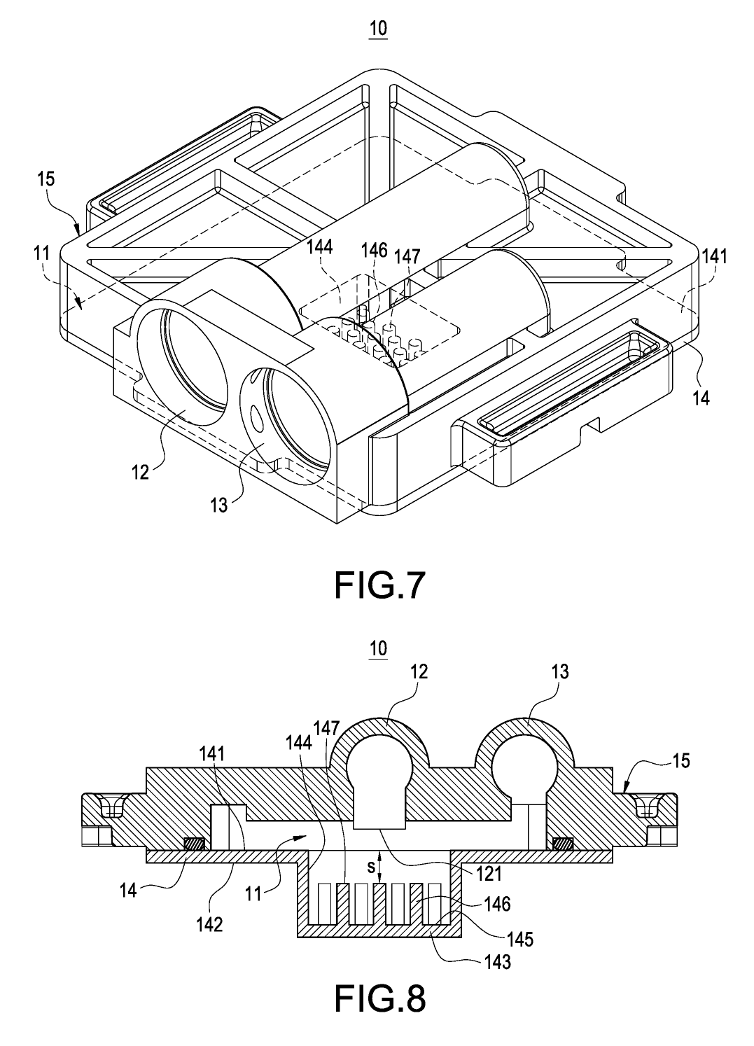

With reference to FIGS. 7 and 8 for a liquid cooling apparatus 10 in accordance with a further preferred embodiment of this disclosure, this preferred embodiment is substantially the same as the preferred embodiment as shown in FIGS. 1 to 5, except that each of the fins 146 of this preferred embodiment is a cylindrical body. In this disclosure, each of the fins 146 is a sheet member, a cylindrical body, or a body with any other geometric shape.

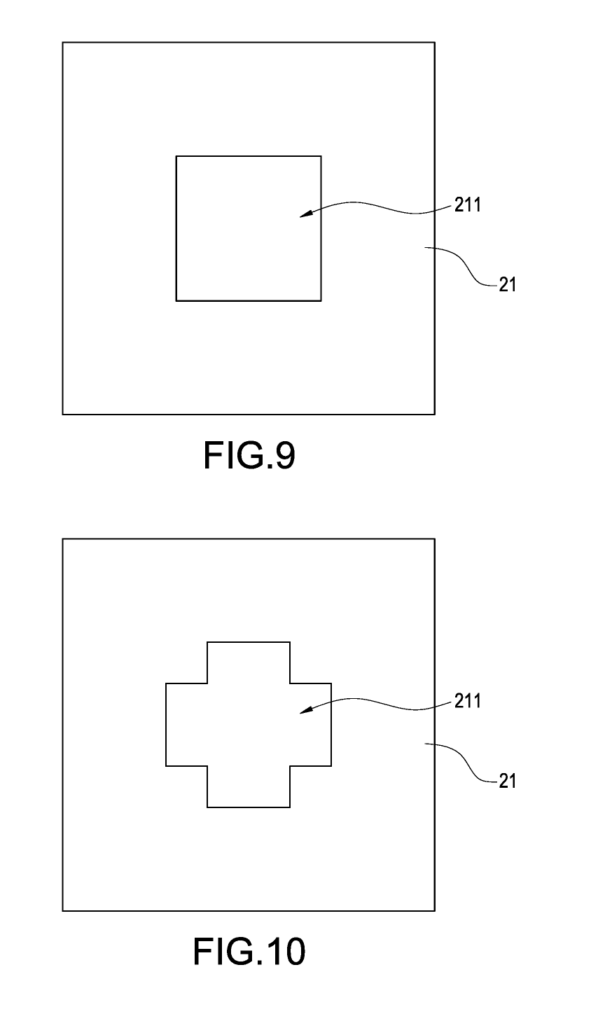

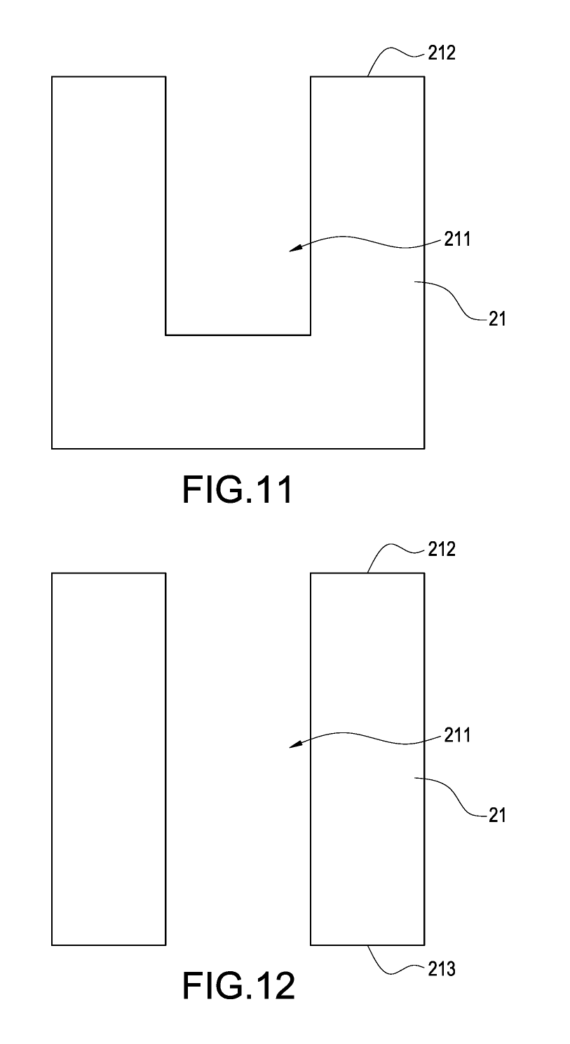

With reference to FIGS. 9 to 12 for a first planar layer 21 in accordance with various embodiments of this disclosure, the shape of the through area 211 of the first planar layer 21 differs in different embodiment. In FIGS. 9 and 10, the through area 211 may be a patterned through slot in a rectangular shape, a cross-shape, a circular shape, a polygonal shape, or any other geometric shape. In FIG. 11, the through area 211 is extended in a direction from a first edge 212 of the first planar layer 21. In FIG. 12, the through area 211 is extended from a first edge 212 of the first planar layer 21 to a second edge 213 of the first planar layer 21.

In summation of the description above, the liquid cooling apparatus, the projector and the apparatus having a heat source in accordance with this disclosure can achieve the expected objectives and overcome the drawbacks of the prior art. In addition, this disclosure complies with patent application requirements, and is thus duly filed for patent application.

While this disclosure has been described by means of specific embodiments, numerous modifications and variations could be made thereto by those skilled in the art without departing from the scope and spirit of this disclosure set forth in the claims.

What is claimed is:

1. A liquid cooling apparatus, comprising:
a chassis, having an upper surface, a lower surface, a boss outwardly protruded from the lower surface, and a recessed groove concavely formed on the upper surface and inside the boss, and the boss having an area smaller than 50% of the area of the lower surface; and
a cover, covering the chassis, and the cover and the chassis jointly having a cavity formed therein, and the cover having a liquid inlet channel and a liquid outlet channel, and the liquid inlet channel and the liquid outlet channel communicating with the cavity separately.

2. The liquid cooling apparatus according to claim 1, wherein the boss has a length smaller than 70% of the length of upper surface and a width smaller than 70% of the width of the upper surface.

3. The liquid cooling apparatus according to claim 1, wherein the boss has a length from 1.0 cm to 4.0 cm, a width from 1.0 to 4.0 cm, and a thickness from 0.5 to 1.5 cm.

4. The liquid cooling apparatus according to claim 1, wherein the recessed groove has a bottom wall on which a plurality of fins are configured.

5. The liquid cooling apparatus according to claim 4, wherein each of the fins has a top lower than the upper surface and a spacing is defined between the top of the fins and the upper surface.

6. The liquid cooling apparatus according to claim 4, wherein each of the fins has a top aligned evenly with the upper surface.

7. The liquid cooling apparatus according to claim 4, wherein each of the fins is a sheet body or a cylindrical body.

8. The liquid cooling apparatus according to claim 4, wherein the liquid inlet channel has a liquid inlet configured to be corresponsive to the top of the fins.

9. A projector, comprising:
a projection module, having at least one first planar layer and a second planar layer stacked on the top of the first planar layer, and the first planar layer having a through slot exposed from a portion of the second planar layer, and a height difference existing between the first planar layer and the second planar layer;
a heat source, installed on the second planar layer, and exposed from the first planar layer through the through slot; and
a liquid cooling apparatus, installed on the first planar layer, and comprising:
a chassis, having an upper surface, a lower surface, a boss outwardly protruded from the lower surface, and a recessed groove concavely formed on the upper surface and inside the boss, and the boss having an area smaller than 50% of the area of the lower surface; and
a cover, covering the chassis, and the cover and the chassis jointly having a cavity formed therein, and the cover having a liquid inlet channel and a liquid outlet channel, and the liquid inlet channel and the liquid outlet channel communicating with the cavity separately, and the boss being passed and installed to the through slot and thermally attached to the heat source.

10. The projector according to claim 9, wherein at least one of the first planar layer and the second planar layer is a circuit board.

11. The projector according to claim 10, wherein the heat source is a digital micro-mirror device (DMD) chip, and the through slot has a length from 1.5 cm to 4.5 cm and a width from 1.5 cm to 4.5 cm.

12. The projector according to claim 9, wherein the boss has a length smaller than 70% of the length of the upper surface and a width smaller than 70% of the width of the upper surface.

13. The projector according to claim 9, wherein the boss has a length from 1.0 cm to 4.0 cm, a width from 1.0 cm to 4.0 cm, and a thickness from 0.5 cm to 1.5 cm.

14. The projector according to claim 9, wherein the recessed groove has a bottom wall on which a plurality of fins are configured.

15. The projector according to claim 14, wherein each of the fins has a top lower than the upper surface and a spacing is defined between the top of the fins and the upper surface.

16. The projector according to claim 14, wherein each of the fins has a top aligned evenly with the upper surface.

17. The projector according to claim 14, wherein each of the fins is a sheet body or a cylindrical body.

18. The projector according to claim 14, wherein the liquid inlet channel has a liquid inlet configured to be corresponsive to the top of the fins.

19. An apparatus having a heat source, comprising:
a first planar layer, having a through area;
a second planar layer, stacked on the first planar layer, and a height difference existing between the first planar layer and the second planar layer;
a heat source, installed on the second planar layer, and exposed from the first planar layer through the through area; and
a liquid cooling apparatus, installed on the first planar layer, and comprising:
a chassis, having an upper surface, a lower surface, a boss outwardly protruding from the lower surface, and a recessed groove being concavely formed on the upper surface and inside the boss, and the boss having an area smaller than 50% of the area of the lower surface; and
a cover, covering the chassis, and the cover and the chassis jointly having a cavity formed therein, and the cover having a liquid inlet channel and a liquid outlet channel, and the liquid inlet channel and the liquid outlet channel communicating with the cavity separately, and the boss being passed and installed to the through slot and thermally attached to the heat source.

20. The apparatus having a heat source according to claim 19, wherein the recessed groove has a bottom wall on which a plurality of fins are configured.
